(19) United States
(12) Patent Application Publication
(10) Pub. No.: US 2026/0087564 A1
(43) Pub. Date: Mar. 26, 2026

(54) METHOD, SYSTEM, DEVICE AND MEDIUM FOR EVALUATING AGRICULTURAL WATER-SAVING POLICIES USING A MACRO-MICRO LINK APPROACH

(71) Applicant: Huazhong Agricultural University, Wuhan (CN)

(72) Inventors: Hang XIONG, Wuhan (CN); Baodong XU, Wuhan (CN); Lin CHEN, Wuhan (CN); Zaiwen FENG, Wuhan (CN); Xiaowen ZHANG, Wuhan (CN); Bowen YANG, Wuhan (CN); Lingyue LI, Wuhan (CN); Pingping LAI, Wuhan (CN)

(73) Assignee: Huazhong Agricultural University, Wuhan (CN)

(21) Appl. No.: 19/403,912

(22) Filed: Nov. 30, 2025

(30) Foreign Application Priority Data
Aug. 4, 2025 (CN) 202511081181.X

(51) Int. Cl. G06Q 50/02; G06Q 10/04; G06Q 30/0202; G06Q 50/06

(52) U.S. Cl. CPC G06Q 50/02; G06Q 10/04; G06Q 30/02024; G06Q 50/06

(57) ABSTRACT

Disclosed is a method of evaluating water saving policies comprising constructing an impact pathway of agricultural water-saving policy, establishing a farm household production decision-making sub-model, and combining agricultural water use estimation sub-model. Water-savings and grain output at the farm household level are aggregated to regional levels by using a scaling-up method, thereby achieving a link-approach evaluation from macro policy to micro farm household decision-making and then to macro policy effects. The system comprises a policy impact pathway construction module, a farm household decision-making simulation module, an agricultural water use estimation module, and a scaling-up module. The method can accurately characterize the impact mechanism of policies on farmer behavior, enhance the comprehensiveness and depth of policy effectiveness evaluation, and dynamically reflect the long-term effects of policies, thereby providing a basis for the formulation and optimization of agricultural water-saving policies.

### TECHNICAL FIELD

The present disclosure relates to the technical field of agricultural water-saving policy evaluation, particularly to a method, a system, a device and a medium for evaluating agricultural water-saving policies using a macro-micro link approach.

### BACKGROUND

Given the increasingly prominent contradiction between supply and demand of water resources, government departments have formulated and issued a series of agricultural water-saving policies. For example, economic incentives such as subsidies are designed to encourage farm households to adopt water-saving irrigation technologies, including drip irrigation and sprinkler irrigation, or to promote rainfed crops. Nevertheless, existing technologies still face the following limitations when evaluating the practical effects of such policies:

(1) Most of the existing evaluation methods focus on statistical summary or local field experiments at the regional level, failing to completely characterize the chain process of “policy-farm household-technology-effect”, resulting in an unclear policy impact pathway and a large deviation between evaluation results and the actual situation.

(2) Current research generally assumes that farm households are completely rational and make technology choices only based on cost and benefit analysis. In fact, whether farm households change their production technology is also affected by psychological factors, such as “whether they are satisfied with past benefits”: if the current situation has met their expectations, even if the new technology has higher economic returns, farm households may maintain their original production methods. Additionally, whether farm households change their production technology will also be influenced by the decisions of the households around them. The existing models fail to fully incorporate this kind of bounded rationality behavior, resulting in errors in predicting the technology extension rate.

(3) The existing technology typically adopts the representative farmer or simple average method, which directly amplifies the results of a few samples to the regional level, ignoring the differences among farm households in land scale, labor force, capital and risk preference, leading to large deviations in the calculation results of regional agricultural water use and crop output.

(4) At present, water measurement equipment is not yet widely available in agricultural production, and the method of estimating agricultural water use based on planting area and average water use per mu (mu: Chinese unit of land measurement that is commonly 666.67 square meters) is not coupled with the actual production decision-making process of farm households, making it difficult to dynamically reflect the impact of different crops, different technical paths and factor input changes on water use, thereby limiting the timeliness and accuracy of policy evaluation.

### SUMMARY

An objective of the present disclosure is to provide a method, a system, a device and a medium for evaluating agricultural water-saving policies using a macro-micro link approach, the limitations of existing technologies are addressed, which can accurately characterize the impact mechanism of policies on farmer behavior, enhance the comprehensiveness and depth of policy effectiveness evaluation, and dynamically reflect the long-term effects of policies, thereby providing a basis for the formulation and optimization of agricultural water-saving policies.

In order to achieve the above objective, the present disclosure provides a method for evaluating agricultural water-saving policies using a macro-micro link approach, the method includes the following steps:
step S1, constructing an impact pathway of agricultural water-saving policy, wherein the impact pathway of agricultural water-saving policy is from macro policy conditions to micro farm household decision-making to micro water-saving results to macro policy effects;
step S2, establishing a farm household production decision-making sub-model, including the following steps:
in a heuristic-exploratory decision-making stage, determining a technology choice set based on a satisfaction level of income changes of the farm household in the past m years;
in an optimization decision-making stage, based on the technology choice set, selecting a technology and a factor allocation scheme with a highest behavioral intention score;
step S3, constructing an agricultural water use estimation sub-model; and
step S4, aggregating a water-savings and a grain output at a farm household level to a regional level by using a scaling-up method.

In some embodiments, in step S2, the satisfaction level is calculated by a cumulative prospect theory, specifically, the prospect value is obtained by combining a value function and a decision weighting function, when the prospect value is greater than 0, a repetition strategy is selected, the technology choice set is a technology used in the previous year, and when the prospect value is less than 0, an optimization strategy is selected, and the technology choice set is all technologies.

In some embodiments, an annual income change of farm households in the past t years is {x₁, . . . xₜ}, and the prospect value is defined as:

$${U}_{i} = {\sum }_{t = m}^{t - 1} = v ( {x}_{t} ) Φ ( {x}_{t} ) ;$$

where Uᵢ represents a prospect value of farm households i, m represents a memory length, v(xₜ) represents a value function, and φ(xₜ) represents a decision weighting function;
when the income change of farm households is exceeds an income change reference point, it is defined as a gain, and the value function v⁺(xₜ) is:

$${v}^{+} ( {x}_{t} ) = {x}_{t}^{{σ}^{+}} ;$$

when the income change of farm households is less than the income change reference point, it is defined as a loss, and the value function v⁻(xₜ) is:

$${v}^{-} ( {x}_{t} ) = - {λ ( - {x}_{t} )}^{{σ}^{-}} ;$$

where σ^{±} represents a risk aversion parameter when farm households face gains or losses, ± corresponds to a gain situation and a loss situation respectively, and λ represents a loss aversion parameter;
the calculation formula of the decision weighting function

$${Φ}_{{x}_{t}}^{\pm }$$

is as follows:

$${Φ}_{{x}_{t}}^{\pm } = {w}^{\pm } [ 1 - F ( {x}_{t} ) ] - {w}^{\pm } [ 1 - F ( {x}_{t} + Δ ) ] ;$$

where w^{±} represents a probability weighting function, Δ represents a difference between the income change and its adjacent values.

In some embodiments, in step S2, the behavioral intention is calculated based on an attitude of the farm household towards a production scheme and a subjective norm score:

$$B {I}_{behav} = {γ}_{1} {BA}_{behav} + {γ}_{2} S {N}_{behav} ;$$

where BI_{behav} represents a behavioral intention score, BA_{behav} represents an attitude score, SN_{behav} represents a subjective norm score, and γ₁ and γ₂ represent weights of attitude and subjective norm, respectively;
the attitude score is calculated based on a maximum expected profit of farm households for a specific production scheme, and the subjective norm score is calculated based on a proportion of farm households adopting specific behaviors in their network:

$${BA}_{t , behav} = \frac{{π}_{t , behav}}{\sum {π}_{t , behav}} ;$$

$$S {N}_{t , behav} = \frac{{n}_{peer , t - 1 , behav}}{N} , peer ∈ {N}_{i} ;$$

where π_{t,behav} represents a production profit of the current farm households using a production decision-making behav in a t year, n_{peer,t-1,behav} represents a number of current peers of the farm households using the production decision-making behav in a t−1 year, and N represents a number of peers that have social relations with the current farm households;
the expected profit of farm households for the specific production scheme includes a production profit and an agricultural water-saving profit under this scheme, a decision-making objective is to maximize a total profit, and the objective function is as follows:

$$max {π}_{product} + {π}_{water} ;$$

where:

$${π}_{product} = {Y}_{product} - {c}_{product} ;$$

$${Y}_{product} = min \{ \frac{labor}{{α}_{1}} , \frac{land}{{α}_{2}} , \frac{fert}{{α}_{3}} , \frac{tech}{{α}_{4}} , \frac{seed}{{α}_{5}} , \frac{pest}{{α}_{6}} , \frac{mach}{{α}_{7}} , \frac{mulch}{{α}_{8}} \} ;$$

$${c}_{product} = {c}_{labor} + {c}_{land} + {c}_{material} ;$$

$${c}_{labor} = {c}_{ownlabor} + {c}_{hirelabor} ;$$

$${c}_{ownlabor} = {price}_{ownlabor} \times labor ;$$

$${c}_{hirelabor} = {price}_{hirelabor} \times ( labor - {labor}_{endow} ) ;$$

$${c}_{land} = {c}_{ownland} + {c}_{transferland} ;$$

$${c}_{ownland} = {price}_{ownland} \times land ;$$

$${c}_{transferland} = {price}_{transferland} \times ( land - {land}_{endow} ) ;$$

$${c}_{material} = {c}_{fert} + {c}_{tech} + {c}_{seed} + {c}_{post} + {c}_{mach} + {c}_{mulch} ;$$

where π_{product} represents a production profit, π_{water} represents an agricultural water-saving profit, Y_{product} represents a production benefit, c_{product} represents a production cost, {labor, land, fert, tech, seed, pest, mach, mulch} represents an input amount of eight production factors, including labor, land, fertilizer, technology, seed, pesticide, machinery and plastic mulch, respectively, {α₁, α₂, α₃, α₄, α₅, α₆, α₇, α₈} represents an input-output coefficient of each production factor, c_{labor} represents a labor cost, c_{land} represents a land cost, cₘₐₜₑᵣᵢₐₗ represents a material cost composed of six kinds of agricultural materials, c_{ownlabor} represents an own labor cost, c_{hirelabor} represents a hired labor cost, labor_{endow} represents an own labor endowment of the farm household, price_{ownlabor} represents an own labor cost per unit, price_{hirelabor} represents a hired labor cost per unit, c_{ownland} represents an own land cost, c_{transferland} represents a transfer land cost, land_{endow} represents an own land endowment of the farm household, price_{ownland} represents a discount rent of own land per unit, price_{transferland} represents a rent of a transferred land per unit, c_{fert} represents a cost of the fertilizer, c_{tech} represents a cost of water-saving technology, c_{seed} represents a cost of seeds, cₚₑₛₜ represents a cost of pesticides, c_{mach} represents a cost of machinery, and c_{mulch} represents a cost of plastic mulch;
the agricultural water-saving profits are as follows:

$${π}_{water} = subsidy + {Y}_{water} - {c}_{water} ;$$

$${c}_{water} = water\_charge + electricity\_charge ;$$

where subsidy represents an agricultural water-saving policy subsidy, Y_{water} represents a water-saving reward for the farm households; c_{water} represents a cost of water and utilities for agricultural production, where water_charge represents a cost of water charged for agricultural water, and electricity_charge represents an electricity charge consumed by pumping water.

In some embodiments, in step S3, the water use estimation sub-model is as follows:
taking agricultural water use as a dependent variable, and taking technical factors, production management factors and field ecological factors as independent variables, constructing an agricultural water use estimation sub-model based on the utilities:

$$Water\_using = pumping\_hours \times pumping\_rate ,$$

$$pumping\_hours = \frac{electricity\_charge}{pump\_power} ;$$

where Water_using represents an agricultural production water use of farm households, pumping_hours represents a duration of water pumping by farm households, pumping_rate represents a water output per unit time, and pump_power represents a pump power.

In some embodiments, in step S3, the water use estimation sub-model is as follows:
taking agricultural water use as a dependent variable, taking meteorological factors, production management factors, field ecological factors and hydrogeological factors as independent variables, constructing an agricultural water use estimation sub-model based on a water balance equation:

$$Water\_using = {ET}_{c} + R + D + Δ S - {P}_{e} ;$$

$${ET}_{c} = {k}_{c} \times {k}_{s} \times {ET}_{0} ;$$

$${k}_{s} = \frac{TAW - SWD}{( 1 - MAD ) \times TAW} ;$$

where Water_using represents an agricultural production water use of farm households, Pₑ represents an effective precipitation, ET_{c} represents a crop evapotranspiration, R represents a surface runoff of farmland, D represents a deep leakage, ΔS represents a change of soil water storage in a crop root layer, ET₀ represents a crop reference evapotranspiration, k_{c} represents a crop parameter, kₛ represents a water stress parameter, TAW represents a total available water, SWD represents a soil water deficit, and MAD represents a management allowable deficit.

In some embodiments, in step S4, the water use and grain output at the farm household level are aggregated to the regional level by using the scaling-up method, specifically as follows:
fitting a joint probability distribution of sample farm households attributes by using a kernel density estimation method;
determining a sampling scale according to a total number of production subjects in an objective region, and randomly generating an attribute data set from the joint probability density distribution;
generating regional policy effect indicators by adding up the agricultural water use and grain output of all production subjects and technology adoption results.

A system for evaluating agricultural water-saving policies using a macro-micro link approach is further provided in the present disclosure, which includes the following:
a policy impact pathway construction module, configured to generate a link-approach pathway from macro policy conditions to micro farm household decision-making to micro-agricultural water use results to macro policy effects;
a farm household decision-making simulation module, configured to establish a farm household production decision-making sub-model, wherein the farm household decision-making simulation module includes:
a heuristic-exploratory decision-making sub-unit, configured to calculate the satisfaction level of income changes of farm households in the past m years based on the cumulative prospect theory and generate a technology choice set;
an optimization decision-making sub-unit, configured to solve and output an optimal technology and a factor allocation scheme based on the technology choice set with a goal of maximizing total profit;
an agricultural water use estimation module, configured to call a pre-stored agricultural water use estimation sub-model to calculate agricultural water use;
a scaling-up module, configured to aggregate the agricultural water use and grain output at the farm household level to the regional level by using the scaling-up method, the scaling-up module includes:
a kernel density estimation unit, configured to fit a joint probability distribution of sample farm households attributes;
a sampling unit, configured to determine a sampling scale according to a total number of production subjects in the objective region, and randomly generate an attribute data set; and
a regional summary unit, configured to generate regional policy effect indicators by adding up the agricultural water use and grain output of all production subjects and technology adoption results.

The present disclosure further provides a computer device, including a memory and a processor, wherein the memory is configured for storing instructions, and the processor is configured for executing the instructions to implement the method for evaluating agricultural water-saving policies using a macro-micro link approach as described above.

The present disclosure further provides a computer-readable storage medium, a computer program is stored on the computer-readable storage medium, and when the computer program is executed by the processor, to implement the method for evaluating agricultural water-saving policies using a macro-micro link approach as described above.

Therefore, the present disclosure adopts the above method, system, device and medium for evaluating agricultural water-saving policies using a macro-micro link approach and the beneficial technical effects are as follows:

(1) In the present disclosure, the whole impact process of agricultural water-saving policies from the macro level to micro farm household behavior and finally to the macro policy effect is completely characterized by constructing a link-approach evaluation pathway of “macro policy conditions→micro farm household decision-making→micro water-saving results→macro policy effects”. This overcomes the limitation that most of the evaluation methods in the prior art stay at the statistical summary or local field experiment at the regional level, and fail to clearly present the chain process of “policy-farm household-technology-effect”, making the policy evaluation more comprehensive and accurate, thus more truly reflecting the actual mechanism and effect of the policy.

(2) In the present disclosure, the bounded rational behavior of farm households is fully considered when establishing the farm household production decision-making sub-model, the satisfaction level of income changes of farm households in the past m years is calculated by adopting the cumulative prospect theory and the technology choice set is determined accordingly. This is more in line with the actual situation than the existing research generally assumes that farm households are completely rational and only choose technology based on cost and benefit analysis.

In actual production decisions, farm households are typically affected by psychological factors such as “whether they are satisfied with past benefits”. If the current situation has met their expectations, farm households may maintain their original production methods even if the new technology has higher economic returns. In the present disclosure, by introducing the accumulative prospect theory, the real decision-making process of farm households when facing new technologies can be better simulated, thereby more accurately predicting the technology extension rate, providing a more reliable decision-making basis for policy makers, and avoiding the technology extension prediction error caused by the erroneous assumption of farm households behavior.

In the present disclosure, when aggregating the results of the farm household level to the regional level, the scaling-up method is used, the joint probability distribution of sample farm households attributes is fitted by combining the kernel density estimation method, the sampling scale is determined according to the total number of production subjects in the objective region, the attribute data set is randomly generated, and finally the regional policy effect indicators are generated by adding up the water-savings and grain output of all production subjects and technology adoption results.

(4) The evaluation method of the present disclosure can dynamically reflect the long-term effects of policies. By simulating decision-making behaviors and water-saving results of farm households in multiple production cycles, and aggregating these results to the regional level, it can be observed that the changing trend of the impact of policies on farm households production behaviors, water saving and grain output at different time stages, thus providing strong support for long-term planning and dynamic adjustment of policies.

### BRIEF DESCRIPTION OF THE DRAWINGS

FIG. 1 is an analysis framework diagram of a mechanism of agricultural water-saving policies;

FIG. 2 is a flowchart of farm households technology adoption and factor allocation decision-making;

FIG. 3 is a flowchart of model operation.

### DETAILED DESCRIPTION OF THE EMBODIMENTS

The technical scheme of the present disclosure is further explained below by drawings and embodiments.

Unless otherwise defined, the technical or scientific terms used in the invention shall be those to which the invention belongs.

### Embodiment 1

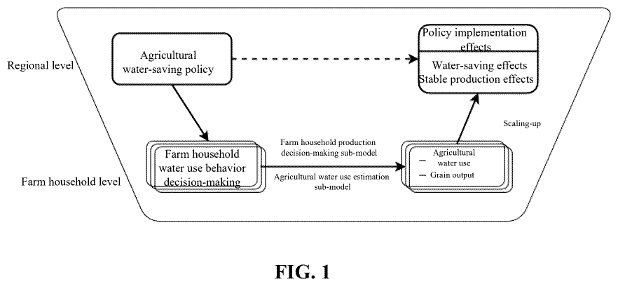

A method for evaluating agricultural water-saving policies using a macro-micro link approach is provided, the method includes the following steps:
step S1, as shown in FIG. 1, the impact pathway of agricultural water-saving policy is constructed, which is specifically macro policy conditions→micro farm household decision-making→micro water use results→macro policy effects.

In which, as the behavior subject, farmers are decision-makers to pursue profit maximization. The subsidy standards for agricultural water-saving policies are divided into measure-based subsidies and performance-based subsidies. Measure-based subsidies can affect the profits of farm households by affecting the cost of technology adoption of farm households, while performance-based subsidies can affect the profits of farm households by affecting the water-saving profits of farm households. Both of them have an impact on the water-saving technology adoption and factor allocation behavior of farm households. Furthermore, the agricultural water use resulting from the adoption of water-saving technologies by farm households is lower than the agricultural water use when using conventional technologies, thereby contributing to water-savings. Additionally, differences in the allocation of production factors can have an impact on grain output. Ultimately, the water-savings and grain output of all farm households are aggregated to present the water-saving effects and grain output at the regional level.

Farm households are characterized by eight attributes, which are: income (income), labor (labor), land (land), ratio of production budget to operating income (ratioᵢₙᵥₑₛₜ), risk aversion parameter (σ^{±}), probability weighting parameter (α^{±}), loss aversion parameter (λ), and income change reference point (ref_{income}), as shown in Table 1.

TABLE 1
Behavior subject attributes

| | Definition | Theoretical value |
|---|---|---|
| Variables | or description | range |
| income | Initial operating income of farm households | [0, +∞] |
| | (CNY) | |
| labor | Initial labor force of farm households (per | [0, +∞] |
| | person) | |
| land | Initial land size of farm households (hm²) | [0, +∞] |
| ratioᵢₙᵥₑₛₜ | Ratio of production budget to operating | [0, 1] |
| | income (%) | |
| σ^{±} | Risk aversion parameter | [0, +∞] |
| α^{±} | Probability weighting parameter | [0, +∞] |
| λ | Loss aversion parameter | [0, +∞] |
| ref_{income} | Income change reference point (CNY) | [−∞, +∞] |

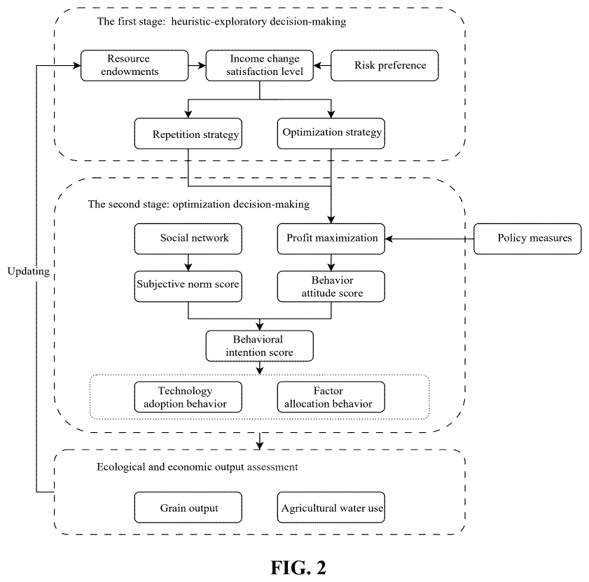

Step S2, as shown in FIG. 2, the farm household production decision-making sub-model is established, which includes the following steps:

In the first stage (the heuristic-exploratory decision-making stage), farm households select either a repetition strategy or optimization strategy based on their satisfaction with annual income changes within the memory period. When farm households are satisfied, they select the repetition strategy, and their technology choice set is the technology used in the previous period. The repetition strategy simulates the behavior of farm households that are unwilling to change due to their satisfaction with the past and current situation, and their consideration of the potential losses that new technologies may bring. When farm households are dissatisfied, they select the optimization strategy, and their technology choice set is all the technologies involved in the model.

The satisfaction level is calculated by the cumulative prospect theory, specifically, the prospect value is obtained by combining the value function and the decision weighting function, when the prospect value is greater than 0, the repetition strategy is selected, the technology choice set is the technology used in the previous year, and when the prospect value is less than 0, an optimization strategy is selected, and the technology choice set is all technologies.

The annual income change of farm households in the past t years is {x₁, . . . xₜ}, and the prospect value is defined as:

$${U}_{i} = {\sum }_{t - m}^{t - 1} = v ( {x}_{t} ) Φ ( {x}_{t} ) ;$$

where Uᵢ represents the prospect value of farm households i, m represents the memory length, v(xₜ) represents the value function, and φ(xₜ) represents the decision weighting function;
when the income change of farm households exceeds the income change reference point, it is defined as the gain, and the value function v⁺(xₜ) is:

$${v}^{+} ( {x}_{t} ) = {x}_{t}^{{σ}^{+}} ;$$

the income change reference point of farm households is represented by the average income changes of farm households within a memory length m, and it changes over time, which is represented as ref_{income}.

When the income change of farm households is less than the income change reference point, it is defined as the loss. At this time, farm households have an aversion to loss, and the value function v⁻(xₜ) is:

$${v}^{-} ( {x}_{t} ) = - {λ ( - {x}_{t} )}^{{σ}^{-}} ;$$

where σ^{±} represents the risk aversion parameter when farm households face gains or losses, ± corresponds to the gain situation and the loss situation respectively, and λ represents the loss aversion parameter, wherein the loss aversion parameter only exists when the income changes of farm households are less than the reference point of income changes. The larger the loss aversion parameter, the more sensitive farm households are to losses.

Given that income changes follow a normal distribution within a memory length of m years, the cumulative distribution function of income changes can be identified as F(xₜ). Based on the assumption that income changes follow the normal distribution, the decision weighing function

$${Φ}_{{x}_{t}}^{\pm }$$

for the weight of income in the prospect value for each period can be calculated, the calculation is as follows:

$${Φ}_{{x}_{t}}^{\pm } = {w}^{\pm } [ 1 - F ( {x}_{t} ) ] - {w}^{\pm } [ 1 - F ( {x}_{t} + Δ ) ] ;$$

where w^{±} represents the probability weighting function, Δ represents the difference between the income change and its adjacent values.

$${w}^{\pm } ( p ) = \frac{{p}^{α \pm }}{{( {p}^{α \pm } + {( 1 - p )}^{α \pm } )}^{1 / α \pm }} ;$$

where α^{±} represents the probability weighting parameter, and when the probability weighting parameter is between 0 and 1, farm households will overestimate small probability events and underestimate large probability events. When the probability weighting parameter is greater than 1, farm households will underestimate small probability events and overestimate large probability events; p represents the objective probability, which is the true probability that an event will occur.

In the second stage (the optimization decision-making stage), the optimal technology and factor allocation scheme with the highest behavioral intention score is solved. Specifically as follows:

The behavioral intention is calculated based on the attitude of the farm household towards the specific production scheme and the subjective norm score:

$${BI}_{behav} = {γ}_{1} {BA}_{behav} + {γ}_{2} {SN}_{behav} ;$$

where BI_{behav} represents the behavioral intention score, BA_{behav} represents an attitude score, SN_{behav} represents the subjective norm score, and γ₁ and γ₂ represent the weight of attitude and subjective norm, respectively;
the attitude score is calculated based on the maximum expected profit of farm households for the specific production scheme, and the subjective norm score is calculated based on the proportion of farm households that adopt specific behaviors in their network:

$${BA}_{t , behav} = \frac{{π}_{t , behav}}{\sum {π}_{t , behav}} ;$$

$${SN}_{t , behav} = \frac{{n}_{peer , t - 1 , behav}}{N} , peer ∈ {N}_{i} ;$$

where π_{t,behav} represents the production profit of the current farm households using the production decision-making behav in the t year, n_{peer,t-1,behav} represents the number of current peers of the current farm households peer using the production decision-making behav in the t−1 year, and N represents the number of peers that have social relations with the current farm households;
the expected profit of farm households for the specific production scheme includes the production profit and the agricultural water-saving profit under this scheme, the decision-making objective is to maximize the total profit, and the objective function is as follows:

$$max {π}_{product} + {π}_{water} ;$$

where:

$${π}_{product} = {Y}_{product} - {c}_{product} ;$$

$${Y}_{product} = min \{ \frac{labor}{{α}_{1}} , \frac{land}{{α}_{2}} , \frac{fert}{{α}_{3}} , \frac{tech}{{α}_{4}} , \frac{seed}{{α}_{5}} , \frac{pest}{{α}_{6}} , \frac{mach}{{α}_{7}} , \frac{mulch}{{α}_{8}} \} ;$$

$${c}_{product} = {c}_{labor} + {c}_{land} + {c}_{material} ;$$

$${c}_{labor} = {c}_{ownlabor} + {c}_{hirelabor} ;$$

$${c}_{ownlabor} = {price}_{ownlabor} \times labor ;$$

$${c}_{hirelabor} = {price}_{hirelabor} \times ( labor - {labor}_{endow} ) ;$$

$${c}_{land} = {c}_{ownland} + {c}_{transferland} ;$$

$${c}_{ownland} = {price}_{ownland} \times land ;$$

$${c}_{transferland} = {price}_{transferland} \times ( land - {land}_{endow} ) ;$$

$${c}_{material} = {c}_{fert} + {c}_{tech} + {c}_{seed} + {c}_{post} + {c}_{mach} + {c}_{mulch} ;$$

where π_{product} represents the production profit, π_{water} represents an agricultural water-saving profit, Y_{product} represents the production benefit, c_{product} represents the production cost, {labor, land, fert, tech, seed, pest, mach, mulch} represents an input amount of eight production factors, including labor, land, fertilizer, technology, seed, pesticide, machinery and plastic mulch, respectively, {α₁, α₂, α₃, α₄, α₅, α₆, α₇, α₈} represents an input-output coefficient of each production factor, c_{labor} represents the labor cost, c_{land} represents the land cost, cₘₐₜₑᵣᵢₐₗ represents the material cost composed of six kinds of agricultural materials, c_{ownlabor} represents the own labor cost, c_{hirelabor} represents the hired labor cost, labor_{endow} represents the own labor endowment of the farm household, price_{ownlabor} represents the own labor cost per unit, price_{hirelabor} represents the hired labor cost per unit, c_{ownland} represents the own land cost, c_{transferland} represents the transfer land cost, land_{endow} represents the own land endowment of the farm household, price_{ownland} represents the discount rent of own land per unit, price transferland represents the rent of a transferred land per unit, c_{fert} represents the cost of the fertilizer, c_{tech} represents the cost of water-saving technology, c_{seed} represents the cost of seeds, cₚₑₛₜ represents the cost of pesticides, c_{mach} represents the cost of machinery, and c_{mulch} represents the cost of plastic mulch;

Since the inputs of labor, land, and agricultural materials require the consumption of the farm household's cash or deposits, and the production costs are constrained by the operating income, labor, and land endowment of the farm household. The farm household will allocate a predetermined ratio of the income from the previous period as the budget for agricultural production in the current year:

$${investment}_{t} = {ratio}_{invest} \times {income}_{t - 1} ;$$

$${c}_{product} \leq {investment}_{t} ;$$

where incomeₜ₋₁ denotes the income of farm household in the t−1 years, ratioᵢₙᵥₑₛₜ denotes the ratio of budget to income, investment, denotes the production budget in the t years, wherein production costs are constrained by production investment, and production investment is constrained by the income of farm households in the previous period and the ratio of production budget to operating income.

The agricultural water-saving profits are as follows:

$${π}_{water} = subsidy + {Y}_{water} - {c}_{water} ;$$

$${c}_{water} = water\_charge + electricity\_charge ;$$

where subsidy represents an agricultural water-saving policy subsidy, Y_{water} represents the water-saving reward (benefits) for the farm households; c_{water} represents the cost of water and utilities for agricultural production, where water_charge represents the cost of water charged for agricultural water, and electricity_charge represents the electricity charge consumed by pumping water.

Step S3, the agricultural water use estimation sub-model is constructed in a modular manner and can be called according to the basic data situation.

The agricultural water use is taken as the dependent variable, and the technical factors, production management factors and field ecological factors are taken as independent variables, the agricultural water use estimation sub-model based on the utilities is constructed:

$$Water\_using = pumping\_hours \times pumping\_rate ;$$

$$pumping\_hours = \frac{electricity\_charge}{pump\_power} ;$$

where Water_using represents the agricultural production water use of farm households, pumping_hours represents the duration of water pumping by farm households, pumping_rate represents the water output per unit time, and pump_power represents the pump power.

The agricultural water use is taken as the dependent variable, the meteorological factors, production management factors, field ecological factors and hydrogeological factors are taken as independent variables, the agricultural water use estimation sub-model based on the water balance equation is constructed:

$$Water\_using = {ET}_{c} + R + D + Δ S - {P}_{e} ;$$

$${ET}_{c} = {k}_{c} \times {k}_{s} \times {ET}_{0} ;$$

$${k}_{s} = \frac{TAW - SWD}{( 1 - MAD ) \times TAW} ;$$

where Water_using represents the agricultural production water use of farm households, Pₑ represents an effective precipitation, ET_{c} represents the crop evapotranspiration, R represents the surface runoff of farmland, D represents the deep leakage, ΔS represents the change of soil water storage in the crop root layer, ET₀ represents the crop reference evapotranspiration, k_{c} represents the crop parameter (which changes with the crop development stage), kₛ represents the water stress parameter, TAW represents the total available water, SWD represents the soil water deficit, and MAD represents the management allowable deficit.

Step S4, the water-savings and the grain output at the farm household level are aggregated to the regional level by using the scaling-up method.

Before scaling-up, it is necessary to determine the production subjects (total number of farm households) in the objective region. The total number of maize-growing farm households in a certain county takes as an example, the number of maize-growing households in the county is 10,735 according to local agricultural census data.

The joint probability distribution of sample farm households attributes is fitted by using the kernel density estimation method.

The sampling scale is determined according to the total number of production subjects in the objective region, and the attribute data set is randomly generated from the joint probability density distribution. Specifically, by randomly sampling from the joint probability distribution generated by kernel density estimation, data of key attributes of the maize households in the province is generated. The sample distribution and overall distribution of key attributes of farm households are basically consistent, which effectively achieves attribute mapping from the individual level to the regional level.

The regional policy effect indicators are generated by adding up the agricultural water use and grain output of all production subjects and technology adoption results.

The following is a detailed description of the operation process of the model proposed in the present disclosure.

### Model Parameters:

Simulation models consist of a large number of parameters, which can be divided into input parameters, intermediate parameters, and output parameters. In which, input parameters are set before the model operation, covering the resource endowment of the farm household, risk preference, reference dependence, production management measures, regional natural environment, government policies, and market factor prices. These parameters are derived from the background conditions of agricultural production and directly affect the decision-making of the farm household and the regional production mode. And the parameters can be generated through relevant materials, historical data, or specific assumptions. The intermediate parameters are generated and temporarily stored during model operation, available for call by subsequent sub-models, including the parameters for the production benefit function, parameters related to the agricultural water use estimation sub-model, prospect value of farm households, and input costs of factors, which reflects the dynamic changes in production decision-making and provided important basis for analysis. The output parameters are the core results calculated by the model based on the input and intermediate parameters, including regional water-savings, grain output value, policy cost and benefit, and water-saving technology adoption rate.

### Model Operation Process:

The development and debugging of the model are performed in the Anaconda3 2024.06-1 (Python 3.12.4) environment, and the development platform is PyCharm Community 2023.3.4.

The operation of the model is performed on the CentOS Linux 7 server cluster.

The setting of the model operating environment includes the policy environment, natural environment, and farm households attributes. In which the water-saving subsidy and water price characterize the policy environment in which farm households are located. Climate data, soil type, and hydrogeological parameters reflect the natural environment in which crops grow. For the setting of farm households parameters, firstly, the joint distribution of key parameters of the sample is characterized based on the data obtained from the survey. Secondly, the number of maize households in the study area is estimated. Finally, sampling is performed based on the joint distribution of the sample. And the sampling is stopped when the sample size reaches the number of maize households in the study area. Additionally, the model also sets parameters for the prices of own and hired labors and own and transferred lands.

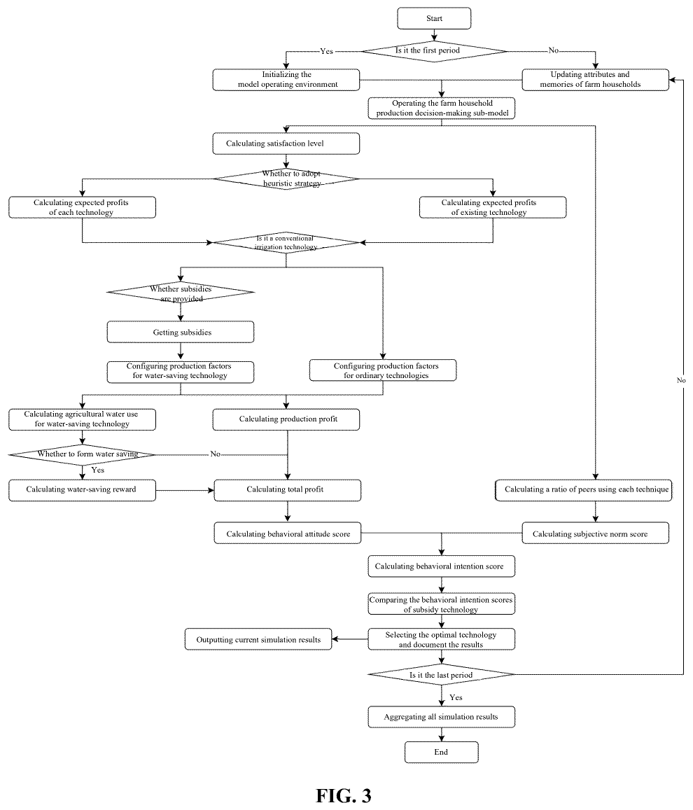

As shown in FIG. 3, the operation process of the model is a process in which each sub-model is executed sequentially and interacts with each other. Firstly, the farm household production decision-making sub-model calculates the satisfaction level based on parameters such as the risk aversion parameter, loss aversion parameter, and income change of the farm household. Based on this, the farm household determines whether to continue using the current technology (repetition strategy) or explore new technologies (optimization strategy), thereby determining the technology choice set. Following this, the sub-model calls upon the optimization algorithm based on parameters such as the resource endowment of farm households and the details of technology implementation, and determines the final technology selection and factor allocation scheme based on behavioral intention scores.

Secondly, the agricultural water use estimation sub-model receives the output results from the farm household production decision-making sub-model and calculates the agricultural water use of each farm household in combination with data on the natural environment and field management measures. Particularly, when the subsidy policy is a water-saving subsidy, the calculation results of water-savings are fed back to the farm household production decision-making sub-model, which affects the expected profits and subsequent decisions of farm households. This leads to cross-execution between sub-models rather than a simple linear process.

After operating for one period, the model updates parameters such as the income and profit of farmers and the adopted technologies. These updated parameters will affect production decision-making in the next year. Once all periods have been operated, the model will aggregate the technology adoption status, water-savings, grain output, and subsidy amounts for each farm household. By using the scaling-up method, these individual-level results will be aggregated at the regional level to generate macro indicators, such as regional water-savings, grain output, technology adoption rates, and policy costs. In this way, the model not only accurately characterizes the impact of policies on the micro-level behavior of farm households but also comprehensively simulates the macro-level effects of policies at the regional level.

### Embodiment 2

A system for evaluating agricultural water-saving policies using a macro-micro link approach is further provided in the present disclosure, which includes the following:
a policy impact pathway construction module, configured to generate the link-approach pathway from macro policy conditions to micro farm household decision-making to micro-agricultural water use results to macro policy effects;
a farm household decision-making simulation module, configured to establish the farm household production decision-making sub-model, wherein the farm household decision-making simulation module includes:
a heuristic-exploratory decision-making sub-unit, configured to calculate the satisfaction level of income changes of farm households in the past m years based on the cumulative prospect theory and generate the technology choice set;
an optimization decision-making sub-unit, configured to solve and output an optimal technology and the factor allocation scheme based on the technology choice set with the goal of maximizing total profit;
an agricultural water use estimation module, configured to call the pre-stored agricultural water use estimation sub-model to calculate agricultural water use;
a scaling-up module, configured to aggregate the agricultural water use and grain output at the farm household level to the regional level by using the scaling-up method, and the scaling-up module includes:
a kernel density estimation unit, configured to fit the joint probability distribution of sample farm households attributes;
a sampling unit, configured to determine the sampling scale according to the total number of production subjects in the objective region, and randomly generate an attribute data set; and
a regional summary unit, configured to generate regional policy effect indicators by adding up the agricultural water use and grain output of all production subjects and technology adoption results.

The aforementioned functions, when implemented as software functional units and sold or used as independent products, can be stored on a computer-readable storage medium. Based on this, the technical solution of the present disclosure, or the part that contributes to the prior art, or part of the technical solution, can be embodied in the form of a software product. This computer software product is stored on a storage medium and includes a certain number of instructions for enabling a computer device (which can be a personal computer, server, or network device, etc.) to execute all or part of the steps of the methods described in the various embodiments of the present disclosure. The aforementioned storage medium includes: USB flash drives, mobile hard drives, read-only memory (ROM), random access memory (RAM), magnetic disks, or optical disks, and other media capable of storing program code.

The logic and/or steps represented in a flowchart or described herein in any other manner, such as a sequenced list of executable instructions for implementing logical functions, may be embodied in any computer-readable medium, designed for use by an instruction execution system, apparatus, or device (such as a computer-based system, a system including a processor, or any other system capable of retrieving and executing instructions from an instruction execution system, apparatus, or device), or in combination with any such instruction execution system, apparatus, or device. For the specification, a “computer-readable medium” may be any device that can contain, store, communicate, propagate, or transmit a program for use by an instruction execution system, apparatus, or device, or in combination with such instruction execution systems, apparatus, or devices.

More specific examples of computer-readable media (non-exhaustive list) include the following: electrical connection parts with one or more wires (electronic devices), portable computer disk cases (magnetic devices), random access memory (RAM), read-only memory (ROM), erasable programmable read-only memory (EPROM or flash memory), optical fiber devices, and portable optical disc read-only memory (CD-ROM). Additionally, computer-readable media may even be paper or other suitable media on which the program may be printed, as the program may be obtained electronically by optical scanning of paper or other media, followed by editing, interpretation, or other appropriate processing if necessary, and then stored in computer memory.

It should be noted that any content not described in detail in the present disclosure is prior art and is well known to those skilled in the art.

Therefore, the present disclosure adopts the aforementioned method, system, device and medium for evaluating agricultural water-saving policies using a macro-micro link approach, the limitations of existing technologies are addressed, which can accurately characterize the impact mechanism of policies on farmer behavior, enhance the comprehensiveness and depth of policy effectiveness evaluation, and dynamically reflect the long-term effects of policies, thereby providing a basis for the formulation and optimization of agricultural water-saving policies.

Finally, it should be noted that the above embodiments are merely used for describing the technical solutions of the present disclosure, rather than limiting the same. Although the present disclosure has been described in detail with reference to the preferred examples, those of ordinary skill in the art should understand that the technical solutions of the present disclosure may still be modified or equivalently replaced. However, these modifications or substitutions should not make the modified technical solutions deviate from the spirit and scope of the technical solutions of the present disclosure.

What is claimed is:

1. A method for evaluating agricultural water-saving policies using a macro-micro link approach, comprising the following steps:
step S1, constructing an impact pathway of agricultural water-saving policy, wherein the impact pathway of agricultural water-saving policy is from macro policy conditions, to micro farm household decision-making, to micro water-saving results, to macro policy effects;
step S2, establishing a farm household production decision-making sub-model, comprising:
in a heuristic-exploratory decision-making stage, determining a technology choice set based on a satisfaction level of income changes of the farm household in past m years;
in an optimization decision-making stage, based on the technology choice set, selecting a technology and a factor allocation scheme with a highest behavioral intention score;
step S3, constructing an agricultural water use estimation sub-model; and
step S4, aggregating a water-savings and a grain output at a farm household level to a regional level by using a scaling-up method.

2. The method for evaluating agricultural water-saving policies using a macro-micro link approach according to claim 1, wherein in step S2, the satisfaction level is calculated by a cumulative prospect theory, wherein a prospect value is obtained by combining a value function and a decision weighting function, wherein, when the prospect value is greater than 0, a repetition strategy is selected and the technology choice set is a technology used in the previous year, and when the prospect value is less than 0, an optimization strategy is selected, and the technology choice set is all technologies.

3. The method for evaluating agricultural water-saving policies using a macro-micro link approach according to claim 1, wherein an annual income change of farm households in the past/years is {x₁, . . . xₜ}, and the prospect value is defined as:
$${U}_{i} = {\sum }_{t - m}^{t - 1} v ( {x}_{t} ) Φ ( {x}_{t} ) ;$$
where Uᵢ represents a prospect value of farm households i, m represents a memory length, v(xₜ) represents a value function, and φ(xₜ) represents a decision weighting function;
wherein, when the income change of farm households exceeds an income change reference point, it is defined as a gain, and the value function v⁺(xₜ) is:
$${v}^{+} ( {x}_{t} ) = {x}_{t}^{{σ}^{+}} ;$$
wherein, when the income change of farm households is less than the income change reference point, it is defined as a loss, and the value function v⁻(xₜ) is:
$${v}^{-} ( {x}_{t} ) = - {λ ( - {x}_{t} )}^{{σ}^{-}} ;$$
where σ^{±} represents a risk aversion parameter when farm households face gains or losses, + or − corresponds to a gain situation or a loss situation respectively, and λ represents a loss aversion parameter;
wherein the calculation formula of the decision weighting function
$${Φ}_{{x}_{t}}^{\pm }$$
is as follows:
$${Φ}_{{x}_{t}}^{\pm } = {w}^{\pm } [ 1 - F ( {x}_{t} ) ] - {w}^{\pm } [ 1 - F ( {x}_{t} + Δ ) ] ;$$
where w^{±} represents a probability weighting function, and Δ represents a difference between the income change and its adjacent values.

4. The method for evaluating agricultural water-saving policies using a macro-micro link approach according to claim 1, wherein in step S2, the behavioral intention is calculated based on an attitude of the farm household towards a production scheme and a subjective norm score:
$${BI}_{behav} = {γ}_{1} {BA}_{behav} + {γ}_{2} {SN}_{behav} ;$$
where BI_{behav} represents a behavioral intention score, BA_{behav} represents an attitude score, SN_{behav} represents a subjective norm score, and γ₁ and γ₂ represent weights of attitude and subjective norm, respectively;
wherein the attitude score BA is calculated based on a maximum expected profit of farm households for a specific production scheme, and the subjective norm score SN is calculated based on a proportion of farm households adopting specific behaviors in their network:
$${BA}_{t , behav} = \frac{{π}_{t , behav}}{\sum {π}_{t , behav}} ;$$
$${SN}_{t , behav} = \frac{{n}_{peer , t - 1 , behav}}{N} , peer ∈ {N}_{i} ;$$
where π_{t,behav} represents a production profit of the current farm households using a production decision-making behav in a t year, n_{peer,t-1,behav} represents a number of current peers of the farm households peer using the production decision-making behav in a t−1 year, and N represents a number of peers that have social relations with the current farm households;
wherein the expected profit of farm households for the specific production scheme comprises a production profit and an agricultural water-saving profit under this scheme, a decision-making objective is to maximize a total profit, and the objective function is as follows:
$$max {π}_{product} + {π}_{water} ;$$
where:
$${π}_{product} = {Y}_{product} - {c}_{product} ;$$
$${Y}_{product} = min \{ \frac{labor}{{α}_{1}} , \frac{land}{{α}_{2}} , \frac{fert}{{α}_{3}} , \frac{tech}{{α}_{4}} , \frac{seed}{{α}_{5}} , \frac{pest}{{α}_{6}} , \frac{mach}{{α}_{7}} , \frac{mulch}{{α}_{8}} \} ;$$
$${c}_{product} = {c}_{labor} + {c}_{land} + {c}_{material} ;$$
$${c}_{labor} = {c}_{ownlabor} + {c}_{hirelabor} ;$$
$${c}_{ownlabor} = {price}_{ownlabor} \times labor ;$$
$${c}_{hirelabor} = {price}_{hirelabor} \times ( labor - {labor}_{endow} ) ;$$
$${c}_{land} = {c}_{ownland} + {c}_{transferland} ;$$
$${c}_{ownland} = {price}_{ownland} \times land ;$$
$${c}_{transferland} = {price}_{transferland} \times ( land - {land}_{endow} ) ;$$
$${c}_{material} = {c}_{fert} + {c}_{tech} + {c}_{seed} + {c}_{pest} + {c}_{mach} + {c}_{mulch} ;$$
where π_{product} represents a production profit, π_{water} represents an agricultural water-saving profit, Y_{product} represents a production benefit, c_{product} represents a production cost, {labor, land, fert, tech, seed, pest, mach, mulch} represents an input amount of eight production factors, comprising labor, land, fertilizer, technology, seed, pesticide, machinery and plastic mulch, respectively, {α₁, α₂, α₃, α₄, α₅, α₆, α₇, α₈} represents an input-output parameter of each production factor, c_{labor} represents a labor cost, c_{land} represents a land cost, cₘₐₜₑᵣᵢₐₗ represents a material cost composed of six kinds of agricultural materials, c_{ownlabor} represents an own labor cost, c_{hirelabor} represents a hired labor cost, labor_{endow} represents an own labor endowment of the farm household, price_{ownlabor} represents an own labor cost per unit, price_{hirelabor} represents a hired labor cost per unit, c_{ownland} represents an own land cost, c_{transferland} represents a transfer land cost, land_{endow} represents an own land endowment of the farm household, price_{ownland} represents a discount rent of own land per unit, price_{transferland} represents a rent of a transferred land per unit, c_{fert} represents a cost of the fertilizer, c_{tech} represents a cost of water-saving technology, c_{seed} represents a cost of seeds, cₚₑₛₜ represents a cost of pesticides, c_{mach} represents a cost of machinery, and c_{mulch} represents a cost of plastic mulch;
wherein the agricultural water-saving profits are as follows:
$${π}_{water} = subsidy + {Y}_{water} - {c}_{water} ;$$
$${c}_{water} = water\_charge + electricity\_charge ;$$
where subsidy represents an agricultural water-saving policy subsidy, Y_{water} represents a water-saving reward for the farm households; c_{water} represents a cost of water and utilities for agricultural production, where water_charge represents a cost of water charged for agricultural water, and electricity_charge represents an electricity charge consumed by pumping water.

5. The method for evaluating agricultural water-saving policies using a macro-micro link approach according to claim 4, wherein in step S3, the water use estimation sub-model is as follows:
taking agricultural water use as a dependent variable, and taking technical factors, production management factors and field ecological factors as independent variables, constructing an agricultural water use estimation sub-model based on the utilities, wherein:
$$Water\_using = pumping\_hours \times pumping\_rate ;$$
$$pumping\_hours = \frac{electricity\_charge}{pump\_power} ;$$
where Water_using represents an agricultural production water use of farm households, pumping_hours represents a duration of water pumping by farm households, pumping_rate represents a water output per unit time, and pump_power represents a pump power.

6. The method for evaluating agricultural water-saving policies using a macro-micro link approach according to claim 1, wherein in step S3, the water use estimation sub-model is as follows:
taking agricultural water use as a dependent variable, taking meteorological factors, production management factors, field ecological factors and hydrogeological factors as independent variables, constructing an agricultural water use estimation sub-model based on a water balance equation, wherein:
$$Water\_using = {ET}_{c} + R + D + Δ S - {P}_{e} ;$$
$${ET}_{c} = {k}_{c} \times {k}_{s} \times {ET}_{0} ;$$
$${k}_{s} = \frac{TAW - SWD}{( 1 - MAD ) \times TAW} ;$$
where Water_using represents an agricultural production water use of farm households, Pₑ represents an effective precipitation, ET_{c} represents a crop evapotranspiration, R represents a surface runoff of farmland, D represents a deep leakage, ΔS represents a change of soil water storage in a crop root layer, ET₀ represents a crop reference evapotranspiration, k_{c} represents a crop parameter, kₛ represents a water stress parameter, TAW represents a total available water, SWD represents a soil water deficit, and MAD represents a management allowable deficit.

7. The method for evaluating agricultural water-saving policies using a macro-micro link approach according to claim 1, wherein in step S4, the water use and grain output at the farm household level are aggregated to the regional level by using the scaling-up method as follows:
fitting a joint probability distribution of sample farm households attributes by using a kernel density estimation method;
determining a sampling scale according to a total number of production subjects in an objective region, and randomly generating an attribute data set from the joint probability density distribution; and
generating regional policy effect indicators by adding up the agricultural water use and grain output of all production subjects and technology adoption results.

8. A system for evaluating agricultural water-saving policies using a macro-micro link approach, comprising:
a policy impact pathway construction module, configured to generate a link-approach pathway from macro policy conditions, to micro farm household decision-making, to micro-agricultural water use results, to macro policy effects;
a farm household decision-making simulation module, configured to establish a farm household production decision-making sub-model, wherein the farm household decision-making simulation module comprises:
a heuristic-exploratory decision-making sub-unit, configured to calculate the satisfaction level of income changes of farm households in the past m years based on the cumulative prospect theory and generate a technology choice set;
an optimization decision-making sub-unit, configured to solve and output an optimal technology and a factor allocation scheme based on the technology choice set with a goal of maximizing total profit;
an agricultural water use estimation module, configured to call a pre-stored agricultural water use estimation sub-model to calculate agricultural water use;
a scaling-up module, configured to aggregate the agricultural water use and grain output at the farm household level to the regional level by using the scaling-up method, wherein the scaling-up module comprises:
a kernel density estimation unit, configured to fit a joint probability distribution of sample farm households attributes;
a sampling unit, configured to determine a sampling scale according to a total number of production subjects in the objective region, and randomly generate an attribute data set; and
a regional summary unit, configured to generate regional policy effect indicators by adding up the agricultural water use and grain output of all production subjects and technology adoption results.

9. A computer device, comprising a memory and a processor, wherein the memory is configured for storing instructions, and the processor is configured for executing the instructions to implement the method for evaluating agricultural water-saving policies using a macro-micro link approach according to claim 1.

10. A computer-readable storage medium, a computer program is stored on the computer-readable storage medium, wherein when the computer program is executed by the processor, to implement the method for evaluating agricultural water-saving policies using a macro-micro link approach according to claim 1.
